(19) United States
(12) Patent Application Publication
(10) Pub. No.: US 2012/0212737 A1
(43) Pub. Date: Aug. 23, 2012

(54) OPTICAL HOMOGENIZING ELEMENTS TO REDUCE SPECTRAL NOISE IN HYPERSPECTRAL IMAGING SYSTEM

(76) Inventors: Lovell E. Comstock, II, Charlestown, NH (US); Jeffrey J. Santman, Keene, NH (US); Richard L. Wiggins, Keene, NH (US)

(21) Appl. No.: 13/033,146

(22) Filed: Feb. 23, 2011

(51) Int. Cl. G01J 3/28

(52) U.S. Cl. 356/326

(57) ABSTRACT

A hyperspectral imaging system and a method are described herein for using an array of optical homogenizing elements to reduce spectral noise in an image of a real-world scene. In one embodiment, the hyperspectral imaging system and method use the array of optical homogenizing elements for homogenizing a spatial, an angular, and a polarization distribution of light from different elements within the real-world scene before it is measured by a spectrometer.

### TECHNICAL FIELD

The present invention relates in general to a hyperspectral imaging system and a method for using an array of optical homogenizing elements to reduce spectral noise in an image of a scene. In one embodiment, the hyperspectral imaging system and method use the array of optical homogenizing elements for homogenizing a spatial, an angular, and a polarization distribution of light from different elements within the scene before it is measured by a spectrometer.

### BACKGROUND

Hyperspectral imaging systems measure the spectral features of objects in real-world scenes. Typically, the scene is broken into a grid and a spectrum is measured for each element of the grid. Hyperspectral imaging is an increasingly important technique in medical diagnosis, agricultural evaluation, and military target identification. To be useful in these applications, the hyperspectral imaging system needs to consistently measure the spectral content of scene elements.

A typical hyperspectral imaging system includes a scanning mirror, an imaging lens, and a spectrometer with an entrance slit and a focal plane array detector. The scanning mirror and lens image a slice of a real-world scene on the spectrometer's entrance slit The focal plane array detector measures the spectra for multiple scene elements along the slice of the scene that falls on the entrance slit. The scanning mirror scans the scene across the entrance slit, allowing the spectra measurement of the scene as multiple slices.

In the field of spectroscopy instrumentation it is well known that obtaining a consistent spectral measurement with a spectrometer requires the illumination at the entrance slit to be homogeneous in spatial distribution, in angular distribution, and in polarization distribution. However, the real-world measurements of hyperspectral imaging do not meet these criteria. A real-world scene will typically vary in spectral content and intensity across the entrance slit. The angular distribution and polarization of light from the real-world scene will also vary across the entrance slit. These variations in the scene originate from differences in scene illumination, the scene observation method, and the detail of the scene structure. The problems caused by non-uniform spectrometer illumination namely scene spectral noise are well-known problems that have existed for a while and have been discussed, for example, within an article by P. Mouroulis et al. “Design of Pushbroom Imaging Spectrometers for Optimum Recovery of Spectroscopic and Spatial Information”, Applied Optics 39, 2210-2220 (2000). The contents of this article are hereby incorporated herein by reference.

The spectral noise introduced by variations in the scene is significantly worse than the detector's noise. The scene spectral noise creates a wavelength shift that is correlated across the entire spectrum. The correlated spectral noise is additive as compared to other uncorrelated noise sources such as detector noise which add randomly. For instance, spectral noise in a hyperspectral imaging system that measures 400 to 900 wavelengths causes a 20 to 30 times larger degradation to multivariate identification than the equivalent random noise such as detector noise. Thus, there is a need to mitigate the scene spectral noise and to obtain a consistent system independent spectral measurement of a scene. This need and other needs are satisfied by the present invention.

### SUMMARY

A hyperspectral imaging system and a method for reducing spectral noise in an image of a scene have been described in the independent claims of the present application. Advantageous embodiments of the hyperspectral imaging system and method have been described in the dependent claims.

In one aspect, the present invention provides a hyperspectral imaging system for measuring spectral features of a scene. The hyperspectral imaging system comprises: (a) an imaging optic for receiving light associated with the scene; (b) an array of optical homogenizers for receiving the light associated with the scene from the imaging optic and homogenizing the received light associated with the scene, where each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end; and (c) a spectrometer including an opening therein for receiving the homogenized light associated with the scene from the array of optical homogenizers and a detector for measuring the spectral features of the scene using the homogenized light associated with the scene that passed through the opening.

In another aspect, the present invention provides a method for reducing the spectral noise in an image of a scene where the spectral noise originates in the measurement of an inhomogenous scene with a spectrometer that is expecting a homogenous input. The method comprises the steps of: (a) providing a hyperspectral imaging system for measuring spectral features of the scene, the hyperspectral imaging system comprising: (i) an imaging optic for receiving light associated with the scene; and (ii) a spectrometer including an opening therein for receiving the light associated with the scene from the imaging optic and a detector for measuring spectral features of the scene using the light associated with the scene that passed through the opening; and (b) placing an array of optical homogenizers between the imaging optic and the spectrometer so that the array of optical homogenizers is positioned to receive the light associated with the scene from the imaging optic and homogenize the received light associated with the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end.

In yet another aspect, the present invention provides a hyperspectral imaging system for measuring spectral features of a scene. The hyperspectral imaging system comprises: (a) an imaging optic for receiving light associated with a portion of elements of the scene; (b) a 1-dimensional array of optical homogenizers for receiving the light associated with the portion of elements of the scene from the imaging optic and homogenizing the received light associated with the portion of elements of the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end; and (c) a spectrometer including an entrance slit therein for receiving the homogenized light from the portion of elements associated with the scene from the 1-dimensional array of optical homogenizers and a detector for measuring the spectral features of the portion of elements associated with the scene using the homogenized light that passed through the entrance slit.

In still yet another aspect, the present invention provides a hyperspectral imaging system for measuring spectral features of a scene. The hyperspectral imaging system comprises: (a) a first imaging optic for receiving light from all elements associated with the scene; (b) a 2-dimensional array of optical homogenizers for receiving the light associated with the scene from the first imaging optic and homogenizing the received light associated with the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end; (c) a second imaging optic for receiving the homogenized light associated with the scene from the 2-dimensional array of optical homogenizers; and (d) a spectrometer including an entrance opening therein for receiving the homogenized light associated with the scene from the second imaging optic and a detector for measuring the spectral features of all the elements associated with the scene using the homogenized light that passed through the entrance opening.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1 is a schematic diagram illustrating the basic components of an exemplary hyperspectral imaging system configured to measure the spectral features of a real-world scene in accordance with an embodiment of the present invention;

FIGS. 2A-2E are diagrams associated with an exemplary hyperspectral imaging system that includes a scanning mirror, an imaging optic, a 1-dimensional array of optical homogenizers, and a spectrometer in accordance with an embodiment of the present invention; and

FIG. 3 is a schematic diagram illustrating an exemplary hyperspectral imaging system that includes a first imaging optic, a 2-dimensional array of optical homogenizers, a second imaging optic, and a spectrometer in accordance with an embodiment of the present invention.

### DETAILED DESCRIPTION

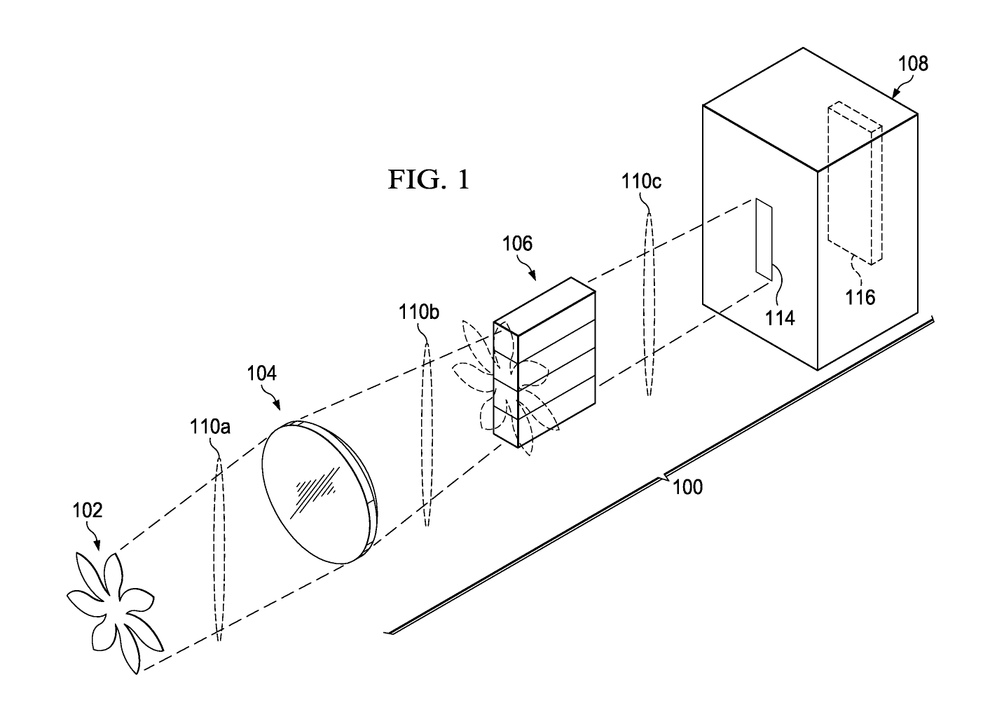

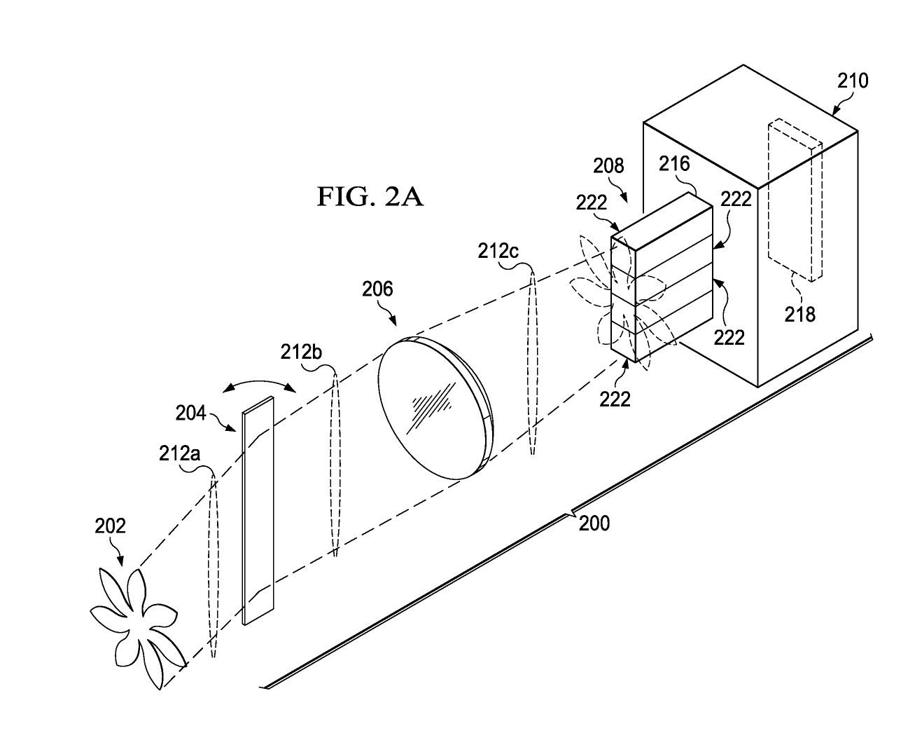

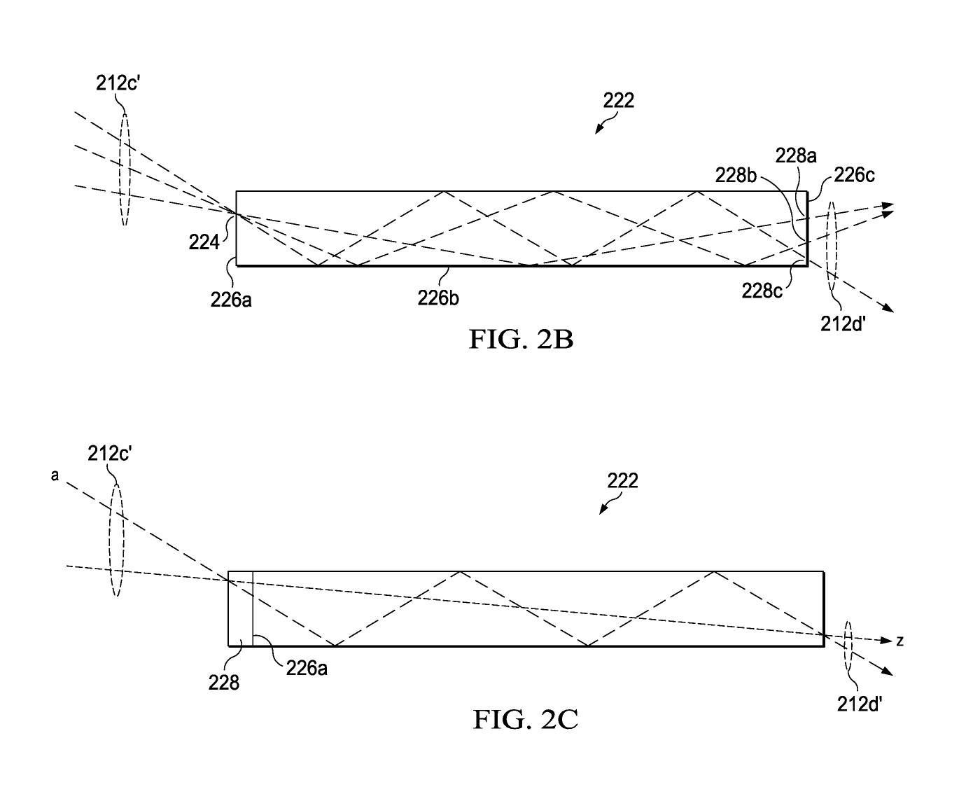

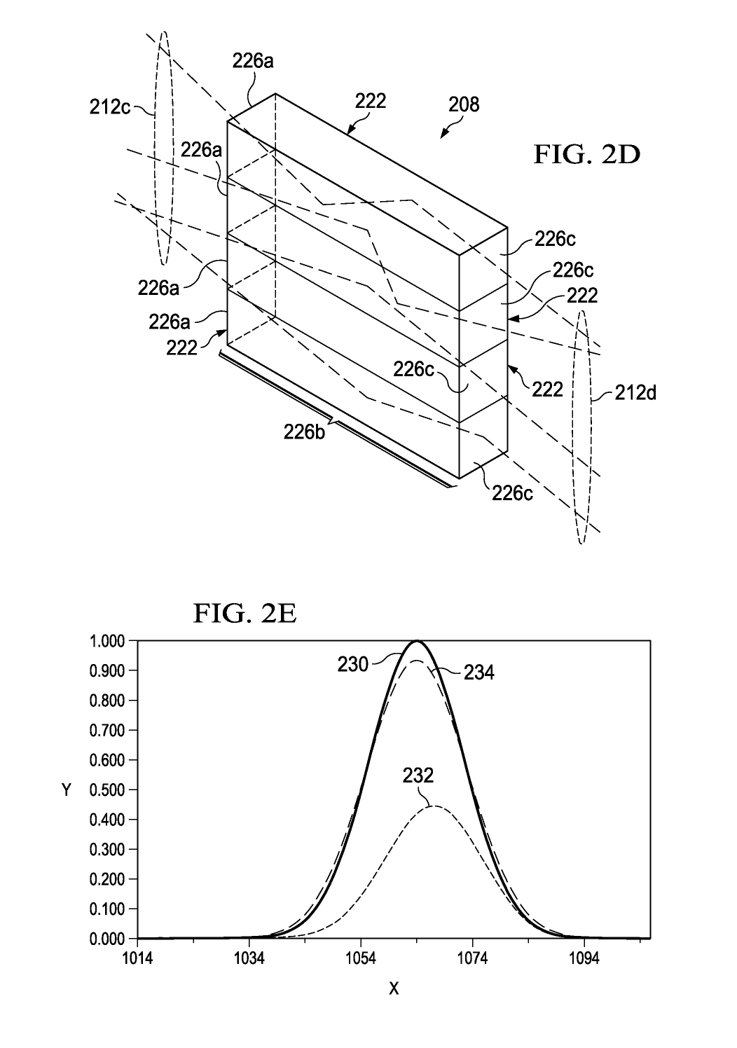

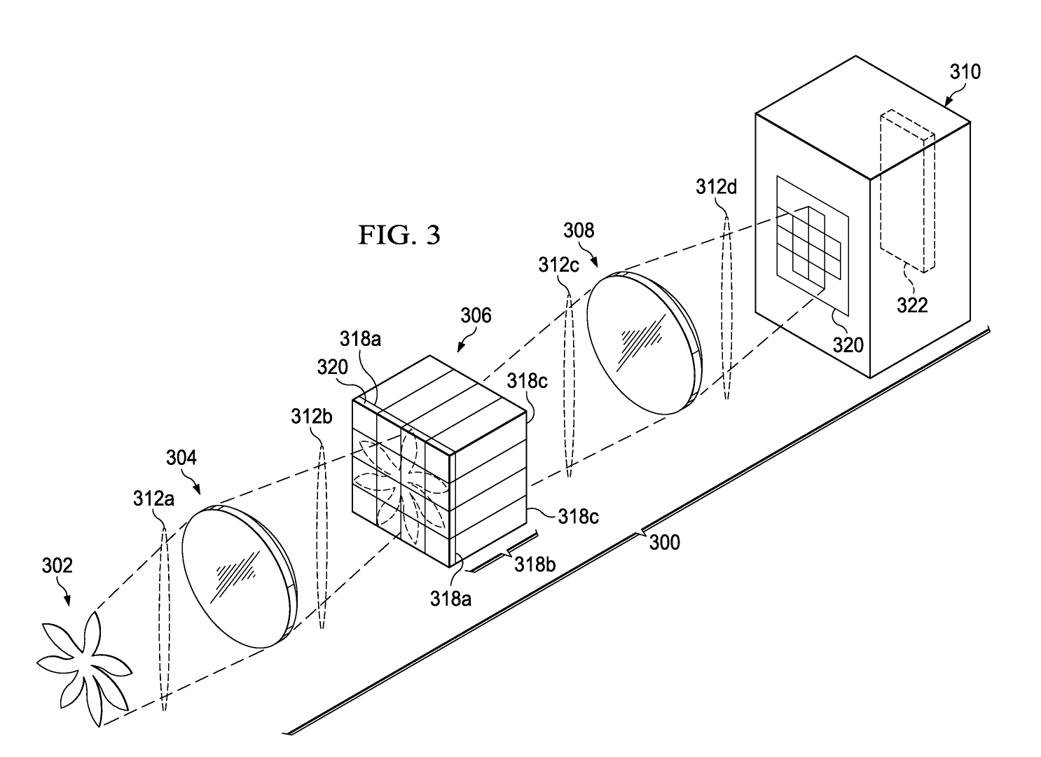

Referring to FIG. 1, there is a block diagram illustrating the basic components of an exemplary hyperspectral imaging system 100 configured to measure spectral features of a real-world scene 102 in accordance with an embodiment of the present invention. The exemplary hyperspectral imaging system 100 includes an imaging optic 104 (shown as a lens 104 but could be a system of lenses, mirrors or a combination of both), an array of optical homogenizers 106, and a spectrometer 108. The imaging optic 104 receives light 110a associated with at least a portion of the scene 102. The array of optical homogenizers 106 receives light 110b associated with at least of portion of the scene 102 from the imaging optic 104 and homogenizes the received light 110b so that a spatial, angular and polarization distribution of the homogenized light 110c which exits therefrom is more uniform than the received light 110b. As shown, the imaging optic 104 forms an image of the scene 102 on the array of optical homogenizers 106. The array of optical homogenizers 106 can be either a 1-dimensional array of optical homogenizers 106 (as shown) (see also FIG. 2A where the 1-dimensional array of optical homogenizers 106 is coupled to the spectrometer 108) or a 2-dimensional array of optical homogenizers 106 (see FIG. 3 where the 2-dimensional array of optical homogenizers 106 is not coupled to the spectrometer 108). The spectrometer 108 includes an opening 114 therein that receives the homogenized light 110c associated with at least a portion of the scene 102 and a detector 116 that measures the spectral features of at least a portion of the scene 102 using the homogenized light 110c. The spectrometer 108 incorporates other components such as mirrors and a grating which are well known to those skilled in the art so for clarity those well known components are not discussed in detail herein. A detail discussion about two different exemplary embodiments of the hyperspectral imaging system 100 is provided below with respect to FIGS. 2A-2E and 3.

Referring to FIGS. 2A-2E, there are various diagrams associated with an exemplary hyperspectral imaging system 200 configured to measure the spectral features of a real-world scene 202 in accordance with an embodiment of the present invention. As shown in FIG. 2A, the exemplary hyperspectral imaging system 200 includes a scanning mirror 204 (optional), an imaging optic 206 (shown as lens 206 but could be a system of lenses, mirrors or a combination of both), a 1-dimensional array of optical homogenizers 208, and a spectrometer 210. The scanning mirror 204 reflects light 212a associated with a portion 214 of the elements of the scene 202 towards the imaging optic 206. The imaging optic 206 (e.g., convex-shaped lens 206) receives light 212b associated with the portion of the elements of the scene 202 and directs focused light 212c associated with the portion of the elements of the scene 202 towards the 1-dimensional array of optical homogenizers 208. The 1-dimensional array of optical homogenizers 208 receives the focused light 212c associated with the portion of the elements of the scene 202 from the imaging optic 206 and homogenizes the focused light 212c associated with the portion of the elements of the scene 202. In this example, the 1-dimensional array of optical homogenizers 208 is made from individual optical homogenizers 222 (four shown) that can be held together by a frame or other mechanical device which is positioned adjacent to the spectrometer 210. The spectrometer 210 includes an entrance slit 216 that receives the homogenized light 212d (see FIGS. 2B-2D) associated with the portion of elements of the scene 202 from the 1-dimensional array of optical homogenizers 208. In addition, the spectrometer 210 includes a detector 218 (e.g., focal plane array detector 218) for measuring the spectral features of the portion of the elements associated with the scene 202 using the homogenized light 212d that had passed through the entrance slit 216. A computer (not shown) which includes a processor and a memory (with a processor executable computer program stored therein) could be used to analyze the output (spectral features of the real-world scene 202) from the detector 218. Alternatively, the exemplary hyperspectral imaging system 200 would not need to incorporate the scanning mirror 204 if pushbroom scanning is utilized in which case the scene 202 would move relative to the system 200 or the system 200 which can be mounted to an aircraft (for example) would move relative to the scene 202.

Referring to FIG. 2B, there is illustrated a side-view of one implementation of an optical homogenizer 222 from the 1-dimensional array of optical homogenizers 208 that shows the details of the homogenization process within a rectangular waveguide in accordance with an embodiment of the present invention. As shown, rays 212c′ from a portion of the received light 212c focus in a narrow cone of angles (narrow angular spread) at a single spot 224 at an input end 226a of the optical homogenizer 222. The rays 212c′ which have a narrow angular spread at the input end 226a will reflect at different angles within a central portion 226b of the optical homogenizer 222. The rays 212c′ after reflecting within the central portion 226b exit an output end 226c of the optical homogenizer 222 at multiple points 228a, 228b and 228c with a wider angular range (wider angular spread) when compared to the rays 212c′ which are received at the input end 226a of the optical homogenizer 222. As can be seen, the optical homogenizer 222 is configured to scramble the received rays 212c′ so that the spatial, angular, and polarization distribution of the rays 212d′ at the output end 226c is much more uniform than the spatial, angular, and polarization distribution of rays 212c′ received at the input end 226a.

Referring to FIG. 2C, there is illustrated a side-view of one optical homogenizer 222 from the 1-dimensional array of optical homogenizers 208 that has been enhanced by attaching an optional scattering element 228 (or diffractive element 228) to the input end 226a thereof in accordance with an embodiment of the present invention. The scattering element 228 functions to enhance the homogenization of the waveguide in the central portion 226b. To illustrate the advantage of using the scattering element 228, there may be a situation where ray 212c′ (long dashed line) would exit the central portion 226b without any homogenization when the optional scattering element 228 is not present. However, the presence of the optional scattering element 228 would make the ray 212c′ (short dashed line) appear to originate from point “a” and in this case when the ray 212c′ originates from point “a” it will be fully homogenized by the central portion 226b of the optical homogenizer 222. For example, the scattering element 228 which is positioned at the homogenizer input end 226a can be made from a coarse ground surface that refracts light in different directions at the different surface slopes, an opalescent glass that refracts light in different directions due to internal index changes, or a diffractive optical element that introduces phase differences to create randomized interference.

Referring to FIG. 2D, there is illustrated a perspective view of the 1-dimensional array of optical homogenizers 208 that shows the details of the homogenization process within the rectangular waveguides (central portions 226b) in accordance with an embodiment of the present invention. As shown, the 1-dimensional array of optical homogenizers 208 includes four optical homogenizers 222 (for example) which are positioned on top of one another and positioned to each receive a portion of rays 212c and separately homogenize their portion of rays 212c to output the homogenized rays 212d. The optical homogenizers 222 can be made for example from optical waveguides using total internal reflection, optical light pipeswhich are internally hollow and use reflective inner surfaces, or microprismatic optical elements that overlap subsections in quasi-random patterns. In this example, each optical homogenizer 222 has a square-shaped input end 226a, a square-shaped central portion 226b that has a length multiple times larger than a diagonal of the square-shaped input end 226a, and a square-shaped output end 226c. Alternatively, each optical homogenizer 222 can have a rectangular-shaped input end 226a, a rectangular shaped central portion 226, and a rectangular-shaped output end 226c. In fact, each optical homogenizer 222 can have any shape so long that it scrambles the received rays 212c such that the spatial, angular, and polarization distribution of the rays 212d at the output end 226c is much more uniform than the spatial, angular, and polarization distribution of rays 212c at the input end 226a. However, the 1-dimensional array of optical homogenizers 208 can not be an array of fibers that are used in a fiber optical faceplate since such an array of fibers has been demonstrated to be ineffective in homogenization.

Referring to FIG. 2E, there is a graph which illustrates the effect that non-uniform illumination has on spectral shift in a measurement using a traditional hyperspectral imaging system (without the 1-dimensional array of optical homogenizers 208) and the exemplary hyperspectral imaging system 200 (with the 1-dimensional array of optical homogenizers 208). In this graph, the x-axis represents wavelength (nm) and the y-axis represents intensity (arbs). The solid line 230 is the input spectrum which has a center at 1064 nm, a Gaussian shape, and a 20 nm full width at half maximum (FWHM). The short-dashed line 232 is the result of the measurement with right-side illumination using a traditional hyperspectral imaging system where the input spectrum is convoluted with a right-side illumination instrumental function including a 4 nm rectangle with a 3 nm displacement. As can be seen, the measurement with right-side illumination shifts by 3 nm which is not desirable. In contrast, the exemplary hyperspectral imaging system 200 addresses this problem as can be seen by the long-dashed line 234 which is the result of a measurement that convolutes the input spectrum with a 10 nm rectangular instrumental function for uniform illumination. Other effects which the exemplary hyperspectral imaging system 200 overcomes include changes in the width of the instrumental response function with entrance angle, changes in the measured signal with variations in scene polarization, and changes in signal with sub-element illumination variations.

Referring to FIG. 3, there is a diagram associated with an exemplary hyperspectral imaging system 300 configured to measure the spectral features of a real-world scene 302 in accordance with an embodiment of the present invention. As shown, the exemplary hyperspectral imaging system 300 includes a first imaging optic 304 (shown as a lens 304 but could be a system of lenses, mirrors or a combination of both), a 2-dimensional array of optical homogenizers 306, a second imaging optic 308 (shown as a lens 308 but could be a system of lenses, mirrors or a combination of both), and a spectrometer 310. The first imaging optic 304 (e.g., convex-shaped first lens 304) receives light 312a associated with all of the elements of the scene 302 and directs focused light 312b associated with all the elements of the scene 302 towards the 2-dimensional array of optical homogenizers 306. The 2-dimensional array of optical homogenizers 306 receives the focused light 312b associated with all the elements of the scene 302 from the first imaging optic 304 and then homogenizes the focused light 312b associated with all the elements of the scene 302. The 2-dimensional array of optical homogenizers 306 is made from individual optical homogenizers 314 (sixteen shown) that can be held together by a frame or other mechanical device. Each optical homogenizer 314 has an input end 318a, a central portion 318b, and an output end 318c where the input end 318a is configured to receive light 312b associated with one element of the scene 302, the central portion 318b is configured to homogenize the received light 312b associated with the one element of the scene 302 so that a spatial, angular and polarization distribution of the homogenized light 312c which exits the output end 318c is more uniform than that of the light 312b that is received at the input end 318a (see also FIG. 2B). If desired, optional scattering elements 320 (or diffractive elements 320) can be attached to the input ends 318a of the optical homogenizers 314 (see FIG. 2C). The second imaging optic 308 (e.g., convex-shaped second lens 308) receives the homogenized light 312c associated with all of the elements of the scene 302 from the 2-dimensional array of optical homogenizers 306 and directs focused light 312d associated with all of the elements of the scene 302 towards the spectrometer 310. The spectrometer 310 includes an entrance opening 320 that receives the focused homogenized light 312d associated with all of elements of the scene 202 from the second imaging optic 308. In addition, the spectrometer 310 includes a detector 322 (e.g., focal plane array detector 322) for measuring the spectral features of all the elements associated with the scene 302 using the focused homogenized light 312d that had passed through the entrance opening 320. A computer (not shown) which includes a processor and memory (with executable computer program stored therein) can be connected to the spectrometer 310 to analyze the output (spectral features of the real-world scene 302) from the detector 322.

From the foregoing, one skilled in the art will appreciate that the hyperspectral imaging system 200 which incorporates the 1-dimensional array of optical homogenizers 208 can effectively measure spectral features of a portion (slice) of the real-world scene 202. In this implementation, each element of the scene 202 is homogenized independently and this independent homogenization preserves the spatial resolution of the scene 202 in the vertical direction. The skilled person will also appreciate that the hyperspectral imaging system 300 which incorporates the 2-dimensional array of optical homogenizers 306 can effectively measure spectral features of the entire real-world scene 302 simultaneously. In this implementation, the 2-dimensional array of optical homogenizers 306 has a size and pitch designed to match the size and pitch of the spectrometer's detector array 322 to preserve the spatial resolution of the entire real-world scene 302. In effect, the hyperspectral imaging systems 100, 200 and 300 by incorporating the array of optical homogenizers 106, 208 and 306 makes the optical real-world scene 102, 202 and 302 appear more uniform that they would otherwise. Ideally, the optical homogenizers 106, 208 and 306 are designed so they do not degrade the spatial and spectral measurements of the real-world scene 102, 202 and 302.

Those skilled in the art will appreciate that although the description provided herein is related to hyperspectral imaging with a spectrometer, they will recognize that the present invention applies as well to other hyperspectral systems such as those based upon passive optical filters, active optical filters such as acousto-optical tunable filters (AOTFs) or liquid crystal tunable filters (LCTFs), and Fourier Transform imaging systems. In addition, those skilled in the art will appreciate that the present invention has a number of advantages some of which are as follows (for example):
(1) The reduction of spectral noise improves the performance of a hyperspectral imaging system by increasing its sensitivity.
(2) The reduction of spectral noise reduces the time and cost of calibration by reducing the sensitivity to inhomogeneity in the calibration apparatus.

In one application, hyperspectral imaging systems can be used to identify scene objects based upon their spectral signatures. In a first analysis step a set of hyperspectral scene images acquired with a hyperspectral imaging system is used to develop a unique correlation between scene objects and the spectral properties of those objects. Determining useful correlations is frequently expensive as it involved acquiring a large amount of data. In the second predictive step, the spectral signatures from new scenes, scenes not used in the analysis step is combined with the previously determined correlation to classify (identify) objects within the new set of scenes. In the past, one of the most significant challenges in hyperspectral imaging is to take the correlation developed on one hyperspectral imaging system and apply it in the predictive step with a second hyperspectral imaging system. The transfer of the correlation from one hyperspectral imaging system to another hyperspectral imaging system is highly desirable because of the expense in developing correlations between scene objects and their spectral signatures. Efforts have been made to calibrate hyperspectral imaging systems to generate identical spectral signatures for identical scene objects, but these efforts have shown marginal success. The efforts have shown marginal success because scene spectral noise is a combination of scene details and instrumental details, however, the instrument details cannot effectively be removed by a calibration process. Therefore, the scene spectral noise degrades the transfer of correlations between the two hyperspectral imaging instruments. The present invention addresses this problem by reducing scene noise which produces a better correlation between scene objects and their hyperspectral signatures during the analysis process. Plus, by reducing the scene noise the present invention produces a better prediction of objects from their spectral signatures in later scenes. And, by removing the inhomogeneity in scene elements the present invention allows the transfer of spectral correlations between hyperspectral imaging systems that have been made nominally identical by calibration with a uniform source.

Although multiple embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the invention as set forth and defined by the following claims. It should also be noted that the reference to the “present invention” or “invention” used herein relates to exemplary embodiments and not necessarily to every embodiment that is encompassed by the appended claims.

1. A hyperspectral imaging system for measuring spectral features of a scene, the hyperspectral imaging system comprising:
an imaging optic for receiving light associated with the scene;
an array of optical homogenizers for receiving the light associated with the scene from the imaging optic and homogenizing the received light associated with the scene, where each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end; and
a spectrometer including an opening therein for receiving the homogenized light associated with the scene from the array of optical homogenizers and a detector for measuring the spectral features of the scene using the homogenized light associated with the scene that passed through the opening.

2. The hyperspectral imaging system of claim 1, wherein the array of optical homogenizers is a 1-dimensional array of optical homogenizers and the opening of the spectrometer is an entrance slit that receives the homogenized light from a portion of the elements associated with the scene.

3. The hyperspectral imaging system of claim 2, wherein each element of the scene is homogenized independently by one of the optical homogenizers to preserve a spatial resolution of the scene.

4. The hyperspectral imaging system of claim 1, wherein the array of optical homogenizers is a 2-dimensional array of optical homogenizers and the opening of the spectrometer is an entrance aperture for receiving the homogenized light from all of the elements associated with the scene.

5. The hyperspectral imaging system of claim 1, wherein a size and a pitch of the 2-dimensional array of optical homogenizers matches a size and a pitch of the detector to preserve a spatial resolution of the scene.

6. The hyperspectral imaging system of claim 1, wherein each optical homogenizer includes a square-shaped input end, a square-shaped output end, and the central portion has a square shape and a length multiple times larger than a diagonal of the square-shaped input end.

7. The hyperspectral imaging system of claim 1, further comprising one or more scattering elements that are attached to the input ends of the array of optical homogenizers.

8. The hyperspectral imaging system of claim 1, wherein the array of optical homogenizers is not an array of optical fibers.

9. A method for reducing spectral noise in an image of a scene, the method comprising the steps of:
providing a hyperspectral imaging system for measuring spectral features of the scene, the hyperspectral imaging system comprising:
an imaging optic for receiving light associated with the scene; and
a spectrometer including an opening therein for receiving the light associated with the scene from the imaging optic and a detector for measuring spectral features of the scene using the light associated with the scene that passed through the opening; and
placing an array of optical homogenizers between the imaging optic and the spectrometer so that the array of optical homogenizers is positioned to receive the light associated with the scene from the imaging optic and homogenize the received light associated with the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end.

10. The method of claim 9, wherein the array of optical homogenizers is a 1-dimensional array of optical homogenizers and the opening of the spectrometer is an entrance slit that receives the homogenized light from a portion of the elements associated with the scene.

11. The method of claim 9, wherein the array of optical homogenizers is a 2-dimensional array of optical homogenizers and the opening of the spectrometer is an entrance aperture for receiving the homogenized light from all of the elements associated with the scene.

12. The method of claim 9, wherein each optical homogenizer includes a square-shaped input end, a square-shaped output end, and the central portion has a square shape and a length multiple times larger than a diagonal of the square-shaped input end.

13. The method of claim 9, further comprising the step of placing one or more scattering elements onto the input ends of the array of optical homogenizers.

14. A hyperspectral imaging system for measuring spectral features of a scene, the hyperspectral imaging system comprising:
an imaging optic for receiving light associated with a portion of elements of the scene;
a 1-dimensional array of optical homogenizers for receiving the light associated with the portion of elements of the scene from the imaging optic and homogenizing the received light associated with the portion of elements of the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end; and
a spectrometer including an entrance slit therein for receiving the homogenized light from the portion of elements associated with the scene from the 1-dimensional array of optical homogenizers and a detector for measuring the spectral features of the portion of elements associated with the scene using the homogenized light that passed through the entrance slit.

15. The hyperspectral imaging system of claim 14, further comprising a scanning mirror positioned between the scene and the imaging optic.

16. The hyperspectral imaging system of claim 14, wherein each optical homogenizer includes a square-shaped input end, a square-shaped output end, and the central portion has a square shape and a length multiple times larger than a diagonal of the square-shaped input end.

17. The hyperspectral imaging system of claim 14, further comprising one or more scattering elements that are attached to the input ends of the 1-dimensional array of optical homogenizers.

18. The hyperspectral imaging system of claim 14, wherein the 1-dimensional array of optical homogenizers is not a 1-dimensional array of optical fibers.

19. A hyperspectral imaging system for measuring spectral features of a scene, the hyperspectral imaging system comprising:
a first imaging optic for receiving light from all elements associated with the scene;
a 2-dimensional array of optical homogenizers for receiving the light associated with the scene from the first imaging optic and homogenizing the received light associated with the scene, wherein each optical homogenizer has an input end, a central portion, and an output end and where the input end is configured to receive light associated with one element of the scene, the central portion is configured to homogenize the received light associated with the one element of the scene so that a spatial, angular and polarization distribution of the homogenized light which exits the output end is more uniform than that of the light received at the input end;
a second imaging optic for receiving the homogenized light associated with the scene from the 2-dimensional array of optical homogenizers; and
a spectrometer including an entrance opening therein for receiving the homogenized light associated with the scene from the second imaging optic and a detector for measuring the spectral features of all the elements associated with the scene using the homogenized light that passed through the entrance opening.

20. The hyperspectral imaging system of claim 19, wherein each optical homogenizer includes a square-shaped input end, a square-shaped output end, and the central portion has a square shape and a length multiple times larger than a diagonal of the square-shaped input end.

21. The hyperspectral imaging system of claim 19, further comprising one or more scattering elements that are attached to the input ends of the 2-dimensional array of optical homogenizers.

22. The hyperspectral imaging system of claim 19, wherein the 2-dimensional array of optical homogenizers is not a 2-dimensional array of optical fibers.
